(19) United States
(12) Patent Application Publication
(10) Pub. No.: US 2026/0284892 A1
(43) Pub. Date: Sep. 24, 2026

(54) POSE CORRECTION APPARATUS AND METHOD THEREOF

(71) Applicants: Kia Corporation, Seoul (KR); Hyundai Motor Company, Seoul (KR)

(72) Inventors: Jun Ho Lee, Hwaseong-si (KR); Seung Won Song, Hwaseong-si (KR)

(21) Appl. No.: 19/260,804

(22) Filed: Jul. 7, 2025

(30) Foreign Application Priority Data
Mar. 21, 2025 (KR) 10-2025-0036785

(51) Int. Cl. B25J 9/16; G01S 17/89

(52) U.S. Cl. CPC B25J 9/1697; B25J 9/1607; G01S 17/89

(57) ABSTRACT

In an embodiment, a pose correction for a robot is provided. Pose information associated with a pose of the robot is obtained using a point cloud, such as one from LiDAR, a second ground information in which at least a portion of a first ground information indicating the ground is corrected, is obtained based at least in part on obtaining the first ground information using the pose information, a first gravity information indicating at least gravity acting on the robot, is obtained based at least in part on obtaining, by an inertial measurement sensor, at least one or more of acceleration of the robot or an angular velocity of the robot, and updating the pose information, based at least in part on correcting one or more of the second ground information or the first gravity information, with respect to one or more of a vector constraint, or an elevation constraint.

### CROSS-REFERENCE TO RELATED APPLICATION

This application claims the benefit of priority to Korean Patent Application No. 10-2025-0036785, filed in the Korean Intellectual Property Office on Mar. 21, 2025, the entire contents of which are incorporated herein by reference.

### TECHNICAL FIELD

The present disclosure relates to a pose correction apparatus and a method thereof, and more particularly, relates to technologies to facilitate correcting pose information associated with a pose of a robot to optimize a map indicating a surrounding environment around the robot, using a vector constraint and an elevation constraint.

### BACKGROUND

In existing simultaneous localization and mapping (SLAM), there is a problem in which an accumulated error occurs when operating a robot for a long time. Such an accumulated error may deepen particularly in a localization and mapping process in a large-scale environment. To address it, there is a need to apply an optimization technique to supplement it.

To reduce an existing position error, in general, an external correction scheme using global positioning is used or a direct error correction scheme via modeling is performed, but this is not suitable for correction in the large-scale environment.

### SUMMARY

The present disclosure has been made to solve the above-mentioned problems occurring in the prior art while advantages achieved by the prior art are maintained intact.

An embodiment of the present disclosure provides a pose correction apparatus to facilitate updating pose information associated with a pose of a robot, using LiDAR and an inertial measurement sensor, and a method thereof.

Another embodiment of the present disclosure provides a pose correction apparatus to facilitate obtaining at least one of a vector constraint or an elevation constraint, or any combination thereof, based on sensor data obtained via LiDAR and an inertial measurement sensor, updating pose information associated with a pose of a robot using it, and updating map information based on the optimized pose information and a method thereof.

The technical problems to be solved by the present disclosure are not limited to the aforementioned problems, and any other technical problems not mentioned herein will be clearly understood from the following description by those skilled in the art to which the present disclosure pertains.

According to an embodiment of the present disclosure, a pose correction apparatus may include light detection and ranging (LiDAR), an inertial measurement sensor, and a processor. The processor may obtain pose information associated with a pose of a robot using a point cloud, based on obtaining the point cloud via the LiDAR, may obtain second ground information in which at least a portion of first ground information indicating the ground is corrected, based on obtaining the first ground information using the pose information, may obtain first gravity information indicating gravity acting on the robot, based on obtaining at least one of acceleration of the robot or an angular velocity of the robot, or any combination thereof, via the inertial measurement sensor, may obtain at least one of a vector constraint or an elevation constraint, or any combination thereof, and may optimize the pose information, based on correcting the at least one of the second ground information or the first gravity information, or the any combination thereof using the at least one of the vector constraint or the elevation constraint, or the any combination thereof. Reference to a “processor” includes operations performed by the processor, as well as to the processor obtaining data or otherwise operating in conjunction with one or more other machines, components, circuits, etc.

In an embodiment, the processor may estimate a ground vector associated with the ground, based on applying a plane fitting algorithm to the first ground information, and may obtain the at least one of the vector constraint or the elevation constraint, or the any combination thereof, using the ground vector.

In an embodiment, the processor may update a height of the robot, using a reference plane obtained via a plane equation generated by the plane fitting algorithm, based on obtaining the plane equation.

In an embodiment, the processor may obtain the first gravity information, while the robot is moving at less than predefined acceleration or a predefined angular velocity.

In an embodiment, the processor may obtain second gravity information to facilitate reducing an error value indicating an error in the first gravity information, based on applying the at least one of the vector constraint or the elevation constraint, or the any combination thereof to the first gravity information.

In an embodiment, the processor may determine whether there is an outlier in at least one of the second ground information or the second gravity information, or any combination thereof, based on applying at least one of graph optimization or uncertainty estimation, or any combination thereof to the at least one of the second ground information or the second gravity information, or the any combination thereof.

In an embodiment, the processor may remove the outlier from the at least one of the second ground information or the second gravity information, or the any combination thereof, when there is the outlier in the at least one of the second ground information or the second gravity information, or the any combination thereof, and may optimize the pose information, using the at least one of the second ground information or the second gravity information, or the any combination thereof, the at least one in which the outlier is removed.

In an embodiment, the processor may optimize the pose information, using the at least one of the second ground information or the second gravity information, or the any combination thereof, when there is no outlier in the at least one of the second ground information or the second gravity information, or the any combination thereof.

In an embodiment, the processor may analyze position information about a position of the robot, based on applying the uncertainty estimation to the at least one of the second ground information or the second gravity information, or the any combination thereof, and may optimize the pose information, based on analyzing the position information.

According to another embodiment of the present disclosure, a pose correction method may include obtaining, by a processor, pose information associated with a pose of a robot using a point cloud, based on obtaining the point cloud via light detection and ranging (LiDAR), obtaining, by the processor, second ground information in which at least a portion of first ground information indicating the ground is corrected, based on obtaining the first ground information using the pose information, obtaining, by the processor, first gravity information indicating gravity acting on the robot, based on obtaining at least one of acceleration of the robot or an angular velocity of the robot, or any combination thereof, via an inertial measurement sensor, obtaining, by the processor, at least one of a vector constraint or an elevation constraint, or any combination thereof, and updating, by the processor, the pose information, based on correcting the at least one of the second ground information or the first gravity information, or the any combination thereof using the at least one of the vector constraint or the elevation constraint, or the any combination thereof.

The pose correction method according to an embodiment may include estimating, by the processor, a ground vector associated with the ground, based on applying the plane fitting algorithm to the first ground information, and obtaining, by the processor, the at least one of the vector constraint or the elevation constraint, or the any combination thereof, using the ground vector.

The pose correction method according to an embodiment may include updating, by the processor, a height of the robot, using a reference plane obtained via a plane equation generated by the plane fitting algorithm, based on obtaining the plane equation.

The pose correction method according to an embodiment may include obtaining, by the processor, the first gravity information, while the robot is moving at less than predefined acceleration or a predefined angular velocity.

The pose correction method according to an embodiment may include obtaining, by the processor, second gravity information to facilitate reducing an error value indicating an error in the first gravity information, based on applying the at least one of the vector constraint or the elevation constraint, or the any combination thereof to the first gravity information.

The pose correction method according to an embodiment may include determining, by the processor, whether there is an outlier in at least one of the second ground information or the second gravity information, or any combination thereof, based on applying at least one of graph optimization or uncertainty estimation, or any combination thereof to the at least one of the second ground information or the second gravity information, or the any combination thereof.

The pose correction method according to an embodiment may include removing, by the processor, the outlier from the at least one of the second ground information or the second gravity information, or the any combination thereof, when there is the outlier in the at least one of the second ground information or the second gravity information, or the any combination thereof, and updating, by the processor, the pose information, using the at least one of the second ground information or the second gravity information, or the any combination thereof, the at least one in which the outlier is removed.

The pose correction method according to an embodiment may include updating, by the processor, the pose information, using the at least one of the second ground information or the second gravity information, or the any combination thereof, when there is no outlier in the at least one of the second ground information or the second gravity information, or the any combination thereof.

The pose correction method according to an embodiment may include analyzing, by the processor, position information about a position of the robot, based on applying the uncertainty estimation to the at least one of the second ground information or the second gravity information, or the any combination thereof, and updating, by the processor, the pose information, based on analyzing the position information.

### BRIEF DESCRIPTION OF THE DRAWINGS

The above and other embodiments, features and advantages of the present disclosure will be more apparent from the following detailed description taken in conjunction with the accompanying drawings:

FIG. 1 illustrates an example of a block diagram associated with a pose correction apparatus according to an embodiment of the present disclosure;

FIG. 2 illustrates an example of updating a map in a pose correction apparatus according to an embodiment of the present disclosure;

FIG. 3 illustrates an example of updating a map in a pose correction apparatus according to an embodiment of the present disclosure;

FIG. 4 illustrates an example of updating a map in a pose correction apparatus according to an embodiment of the present disclosure;

FIG. 5 illustrates an example of calculating uncertainty of factors, in an embodiment of the present disclosure;

FIG. 6 illustrates an example of a graph associated with a robust kernel to facilitate removing an outlier, in an embodiment of the present disclosure;

FIG. 7A illustrates an example of a graph associated with a Geman-McClure penalty function, in an embodiment of the present disclosure;

FIG. 7B illustrates an example of a graph associated with an objective function, in an embodiment of the present disclosure;

FIG. 8 illustrates an example of an updated map generated by a pose correction apparatus according to an embodiment of the present disclosure;

FIG. 9 illustrates an example of a flowchart associated with a pose correction method according to an embodiment of the present disclosure; and

FIG. 10 illustrates a computing system associated with a pose correction apparatus or a pose correction method according to an embodiment of the present disclosure.

### DETAILED DESCRIPTION OF ILLUSTRATIVE EMBODIMENTS

Hereinafter, some embodiments of the present disclosure will be described in detail with reference to the exemplary drawings. In adding the reference numerals to the components of each drawing, it should be noted that the identical component is designated by the identical numerals even when they are displayed on other drawings. Further, in describing the embodiment of the present disclosure, a detailed description of well-known features or functions will be ruled out in order not to unnecessarily obscure the gist of the present disclosure.

In describing components of exemplary embodiments of the present disclosure, the terms first, second, A, B, (a), (b), and the like may be used herein. These terms are only used to distinguish one component from another component, but do not limit the corresponding components irrespective of the order or priority of the corresponding components. Furthermore, unless otherwise defined, all terms including technical and scientific terms used herein have the same meaning as being generally understood by those skilled in the art to which the present disclosure pertains. Such terms as those defined in a generally used dictionary are to be interpreted as having meanings equal to the contextual meanings in the relevant field of art, and are not to be interpreted as having ideal or excessively formal meanings unless clearly defined as having such in the present application.

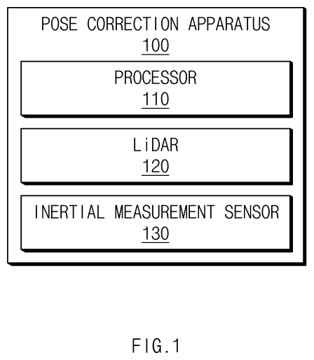

Hereinafter, embodiments of the present disclosure will be described in detail with reference to FIGS. 1 to 10.

It is described that the pose of a robot is updated in the present disclosure, but updating the pose of the robot may include updating a map corresponding to a surrounding environment around the robot. In detail, because of obtaining the map corresponding to the surrounding environment around the robot, using the pose of the robot, updating the pose of the robot may be substantially the same as updating the map. Thus, in the present disclosure, a description will be given of updating the pose of the robot. However, an embodiment of the present disclosure is to update the map corresponding to the surrounding environment around the robot, together with updating the pose of the robot.

FIG. 1 illustrates an example of a block diagram associated with a pose correction apparatus according to an embodiment of the present disclosure.

Referring to FIG. 1, a pose correction apparatus 100 according to an embodiment of the present disclosure may be implemented insider or outside a vehicle and some of the components included in the pose correction apparatus 100 may be implemented inside or outside the vehicle. In this case, the pose correction apparatus 100 may be integrally configured with control units in the vehicle or may be implemented as a separate device to be connected with the control units of the vehicle by a separate connection means. For example, the pose correction apparatus 100 may further include components which are not shown in FIG. 1.

The pose correction apparatus 100 according to an embodiment may include a processor 11o, light detection and ranging (LiDAR) 120, and an inertial measurement sensor 130. The processor 11o, the LiDAR 120, and the inertial measurement sensor 130 may be electronically and/or operably coupled with each other by an electronical component including a communication bus.

Hereinafter, that pieces of hardware are operably coupled with each other may include that a direct connection or an indirect connection between the pieces of hardware is established wired and/or wirelessly, such that second hardware is controlled by first hardware among the pieces of hardware. The hardware components are shown as the different blocks, but an embodiment is not limited thereto. Some of the pieces of hardware of FIG. 1 may be included in a single integrated circuit including a system on a chip (SoC). The types and/or the number of the pieces of hardware included in the pose correction apparatus 100 are/is not limited to those shown in FIG. 1. For example, the pose correction apparatus 100 may include only some of the pieces of hardware shown in FIG. 1.

The pose correction apparatus 100 according to an embodiment may include hardware to facilitate processing data based on one or more instructions. The hardware to facilitate processing the data may include the processor 11o. The hardware to facilitate processing the data may include an arithmetic and logic unit (ALU), a floating point unit (FPU), a field programmable gate array (FPGA), a central processing unit (CPU), and/or an application processor (AP). The processor 110 may have a structure of a single-core processor or may have a structure of a multi-core processor including a dual core, a quad core, a hexa core, or an octa core.

The LiDAR 120 of the pose correction apparatus 100 according to an embodiment may obtain a dataset to facilitate identifying a surrounding thing around the pose correction apparatus 100 (or a robot including the pose correction apparatus 100). For example, the LiDAR 120 may identify at least one of a position of the surrounding thing, a motion direction of the surrounding thing, or a speed of the surrounding thing, or any combination thereof, based on that a pulse laser signal radiated from the LiDAR 120 is reflected from the surrounding thing to return.

For example, the LiDAR 120 may obtain datasets representing an external object on a space formed by an x-axis, a y-axis, and a z-axis, based on the pulse laser signal reflected from the surrounding thing. For example, the LiDAR 120 may obtain datasets including a plurality of points in the space formed by the x-axis, the y-axis, and the z-axis, based on receiving the pulse laser signal at a predefined period.

The processor 110 included in the pose correction apparatus 100 according to an embodiment may radiate light from the robot using the LiDAR 120. For example, the processor 110 may receive the light radiated from the robot. For example, the processor 110 may identify at least one of a position of the surrounding thing, a speed of the surrounding thing, or a motion direction of the surrounding thing, or any combination thereof, based on a time taken to transmit the light radiated from the robot and a time taken to receive the light radiated from the robot.

For example, the processor 110 may obtain the datasets including the plurality of points, based on the time taken to transmit the light radiated from the robot and the time taken to receive the light radiated from the robot. The processor 110 may obtain datasets representing the plurality of points corresponding to the surrounding thing (or the external object), on a three-dimensional (3D) virtual coordinate system including an x-axis, a y-axis, and a z-axis.

The inertial measurement sensor 130 included in the pose correction apparatus 100 according to an embodiment may include at least one of a gyro sensor, an acceleration sensor, a geomagnetic sensor, or an inertial measurement unit (IMU), or any combination thereof. For example, the inertial measurement sensor 130 may obtain at least one of gravity acting on the robot or acceleration acting on the robot, or any combination thereof. However, an embodiment of the present disclosure is not limited to those described above.

Hereinafter, a description will be given of an embodiment in which the pose correction apparatus 100 updates (or corrects) pose information associated with a pose of the robot and updates a map in a predefined distance from the robot using the updated pose information.

The processor 110 of the pose correction apparatus 100 according to an embodiment may obtain a point cloud associated with the surrounding environment around the robot, via the LiDAR 120. For example, the point cloud associated with the surrounding environment around the robot may include at least one of a point cloud corresponding to the ground or a point cloud corresponding to an obstacle located around the robot, or any combination thereof. The example of the point cloud is not limited to those described above.

In an embodiment, the processor 110 may obtain pose information associated with the pose of the robot using the point cloud, based on obtaining the point cloud via the LiDAR 120. For example, the pose of the robot may include at least one of a roll value, a pitch value, or a height from the ground of the robot, or any combination thereof. The height from the ground of the robot may include a height at which at least one of the inertial measurement sensor 130 included in the robot or the LiDAR 120 included in the robot, or any combination thereof is located.

In an embodiment, the processor 110 may obtain first ground information indicating the ground using the pose information associated with the pose of the robot. For example, the processor 110 may obtain second ground information in which at least a portion of the first ground information indicating the ground is corrected, based on obtaining the first ground information using the pose information.

For example, the second ground information may be obtained by pre-rotating the point cloud obtained via the LiDAR 120, using the first ground information, the roll value, the pitch value, and the z-axis value.

In an embodiment, the processor 110 may obtain at least one of acceleration of the robot or an angular velocity of the robot, or any combination thereof, via the inertial measurement sensor 130. For example, the processor 110 may obtain first gravity information indicating gravity acting on the robot, based on obtaining the at least one of the acceleration of the robot or the angular velocity of the robot, or the any combination thereof, via the inertial measurement sensor 130. However, an embodiment of the present disclosure is not limited to those described above. The processor 110 may obtain the first gravity information indicating the gravity acting on the robot, based on obtaining the acceleration of the robot, via the inertial measurement sensor 130.

In an embodiment, the processor 110 may obtain at least one of a vector constraint or an elevation constraint, or any combination thereof, which is to facilitate correcting at least one of the second ground information or the first gravity information, or any combination thereof.

In an embodiment, the processor 110 may correct the at least one of the second ground information or the first gravity information, or the any combination thereof, using the at least one of the vector constraint or the elevation constraint, or the any combination thereof. For example, the processor 110 may update the pose information, based on correcting the at least one of the second ground information or the first gravity information, or the any combination thereof, using the at least one of the second ground information or the first gravity information, or the any combination thereof, using the at least one of the vector constraint or the elevation constraint, or the any combination thereof.

According to an embodiment, the processor 110 may update map information corresponding to the surrounding environment around the robot, based on updating the pose information.

In an embodiment, the processor 110 may apply a plane fitting algorithm to the first ground information. The processor 110 may estimate a ground vector associated with the ground, based on applying the plane fitting algorithm to the first ground information. For example, the ground vector may include a vector which is perpendicular to the ground and is a direction opposite to the gravity direction.

In an embodiment, the processor 110 may obtain a plane equation generated by the plane fitting algorithm. For example, the processor 110 may update a height of the robot (or a height at which the LiDAR 120 is located), using a reference plane using the plane equation generated by the plane fitting algorithm, based on obtaining the plane equation.

In an embodiment, while the robot is moving at less than predefined acceleration and a predefined angular velocity, the processor 110 may obtain the first gravity information. For example, the predefined acceleration may include about 0.1 g. For example, the predefined angular velocity may include 0.1 rad/s. Furthermore, the processor 110 may obtain the first gravity information, based on that an output value indicating the acceleration of the robot, which is output from the inertial measurement sensor 130, is less than a threshold. For example, the threshold may include about 1.1 g. In the present disclosure, describing the predefined acceleration, the predefined angular velocity, and/or the threshold is illustratively describing a condition in which the robot performs uniform motion and is not limited to the above-mentioned example. Thus, an embodiment of the present disclosure is not limited to those described above.

In an embodiment, the processor 110 may obtain second gravity information to facilitate reducing an error value indicating an error in the first gravity information, based on applying the at least one of the vector constraint or the elevation constraint, or the any combination thereof to the first gravity information.

In an embodiment, the processor 110 may identify whether there is an outlier in at least one of the second ground information or the second gravity information, or any combination thereof, based on applying at least one of graph optimization or uncertainty estimation, or any combination thereof to the at least one of the second ground information or the second gravity information, or the any combination thereof.

In an embodiment, when there is the outlier in the at least one of the second ground information or the second gravity information, or the any combination thereof, the processor 110 may remove the outlier from the at least one of the second ground information or the second gravity information, or the any combination thereof.

The processor 110 may update the pose information, using at least one of the second ground information in which the outlier is removed or the second gravity information in which the outlier is removed, or any combination thereof.

In an embodiment, when there is no outlier in the at least one of the second ground information or the second gravity information, or the any combination thereof, the processor 110 may update the pose information, using the at least one of the second ground information or the second gravity information, or the any combination thereof. In detail, when there is no outlier in the second ground information and the second gravity information, the processor 110 may update the pose information using the second ground information and the second gravity information.

In an embodiment, the processor 110 may apply the uncertainty estimation to the at least one of the second ground information or the second gravity information, or the any combination thereof. The processor 110 may analyze position information about the position of the robot, based on applying the uncertainty estimation to the at least one of the second ground information or the second gravity information, or the any combination thereof. The processor 110 may update the pose information, based on the position information.

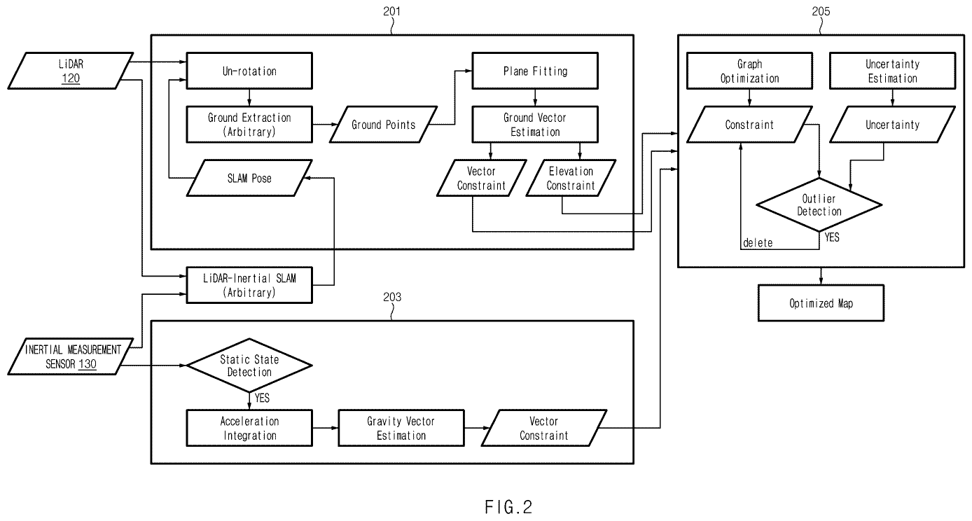

FIG. 2 illustrates an example of updating a map in a pose correction apparatus according to an embodiment of the present disclosure.

Referring to FIG. 2, a processor (e.g., a processor 110 of FIG. 1) of a pose correction apparatus (e.g., a pose correction apparatus 100 of FIG. 1) may include LiDAR 120 and/or an inertial measurement sensor 130.

For example, in a ground information detection module 201, the processor may perform simultaneous localization and mapping (SLAM) for LiDAR data obtained via the LiDAR 120. For example, the processor may perform the SLAM for the LiDAR data obtained via the LiDAR 120, using sensor data obtained via the inertial measurement sensor 130. At this time, the processor may obtain a roll value, a pitch value, and a z-axis value to perform pre-rotation for LiDAR points obtained via the LiDAR 120.

For example, the processor may extract arbitrary ground information. The processor may apply plane fitting to ground points included in the arbitrary ground information, based on extracting the arbitrary ground information. The processor may estimate a ground vector, based on applying the plane fitting.

For example, the processor may obtain at least one of a vector constraint or an elevation constraint, or any combination thereof, using components included in the ground vector. For example, the processor may estimate the ground vector as arg min_{a,b,c,d} (ax+by +cz+d). The processor may obtain the vector constraint using a, b, and/or c, from the estimated ground vector. The processor may obtain the elevation constraint using d, from the estimated ground vector. It may be assumed that the estimated ground vector is estimated on all the same plane. The vector constraint may be 3 dimensions (3D) and 2 degrees of freedom (2DoF) and the elevation constraint may be a 1 dimension (1D) and a 1 degree of freedom (1DoF).

For example, the processor may discriminate between a ground point and a non-ground point. For example, the processor may apply a plane fitting algorithm to the ground point, based on discriminating between the ground point and the non-ground point. The processor may calculate a plane equation corresponding to ax+by+cz+d=o, based on applying the plane fitting algorithm to the ground point. The processor may compare a normal vector component of the calculated plane equation with one ground normal vector which is determined as criteria. The one ground normal vector determined as the criteria may include (ζ_{ref},θ_{ref}, φ_{ref}). The processor may set it to an arbitrary value, (0, 0, 1), and may compare the set value with a normal vector of the plane equation.

In an embodiment, when the result of plane detection is accurate, the processor may update the obtained ground to have the same normal vector, based on defining and updating a factor to facilitate minimizing a Euclidean distance which is a difference between the normal vector and the ground normal vector.

For example, the processor may update all ground surfaces to have the same height from the robot, based on one height value, z_ref, which is determined on the basis of d, in the plane equation, ax+by+cz+d=o. d may be included in the elevation constraint.

In an embodiment, in a gravity information detection module 203, the processor may identify whether the robot is in a static state. For example, the processor may identify whether the robot is in the static state, using an inertial measurement sensor 130 including at least one of an acceleration sensor or a gyro sensor, or any combination thereof. For example, the state in which the robot is static may include the case in which the acceleration of the robot is less than 0.1 g and the angular velocity of the robot is less than 0.1 rad/s. For example, the state in which the robot is not static may include the case in which the acceleration of the robot is greater than or equal to 0.1 g or the angular velocity of the robot is greater than or equal to 0.1 rad/s. However, an embodiment of the present disclosure is not limited to those described above.

In an embodiment, when the inertial measurement sensor 130 is a 9-axis sensor and when the inertial measurement sensor 130 is a 6-axis sensor, the processor may differently operate. For example, when the inertial measurement sensor 130 is the 9-axis sensor, the processor may obtain a vector constraint, using sensor data of the inertial measurement sensor 130. For example, when the inertial measurement sensor 130 is the 6-axis sensor, the processor may apply a complementary filter to the sensor data of the inertial measurement sensor 130 to perform orientation estimation, thus obtaining the vector constraint.

In an embodiment, the processor may generate a pose-graph, using the ground information detection module 201, the gravity information detection module 203, and an initial pose of the robot. In detail, in an optimization module 205, the processor may generate the pose-graph and may update the pose of the robot. For example, the pose-graph may be obtained by

$${x}^{*} = arg min {\sum }_{i} {\sum }_{j} ( {e}_{ij}^{T} Ω {e}_{ij} ) .$$

Furthermore, eᵢⱼ meets eᵢⱼ

$$∈ \{ {d}_{v i}^{P} , {d}_{z i}^{P} , {d}_{v i}^{O} , d ( {T}_{i} , {T}_{j} ) \}$$

and this refers to an error. The processor may identify a pose of the robot to facilitate minimizing the error and may control the robot to the pose, thus updating the pose of the robot.

$${d}_{v i}^{P}$$

may include a vector constraint obtained by the LiDAR 120.

$${d}_{z i}^{P}$$

may include an elevation constraint.

$${d}_{vi}^{O}$$

may include a vector constraint obtained by the inertial measurement sensor 130. It is described in common that it is the vector constraint. However, the vector constraint obtained by the LiDAR 120 may be referred to as a first vector constraint and the vector constraint obtained by the inertial measurement sensor 130 may be referred to as a second vector constraint.

The processor may perform the operation described above and may sequentially update a Jacobian and covariance to update uncertainty, at the same time as minimizing the error. The processor may apply a switchable constraint and a robust kernel to the updated uncertainty to remove an outlier factor.

In an embodiment, the processor may perform optimization to facilitate minimizing a difference between gravity measured at the current position of the robot and a gravity direction measured at criteria, using a loss function. For example, the processor may perform the optimization, using ∥Rᵢ \vec{g}−R_{ref}\vec{g}∥. For example, Rᵢ indicates the result of performing rotation transformation at each pose of the robot, which may be Rᵢ=Rₓ(ψ)R_{y}(θ)R_{z}(φ). R_{ref} may be pose rotation transformation at criteria, which may be R_{ref}=Rₓ(ψ_{ref})R_{y}(θ_{ref})R_{z}(φ_{ref}). \vec{g} indicates a gravity direction, which may be \vec{g}=(0, 0, −1).

In the above process, Rᵢ \vec{g} and R_{ref} \vec{g} may be 3D vectors. The processor may calculate a cosine angle between the two vectors and may perform optimization to make the cosine angle o. However, because the DoF needing optimization in the foremost direction is 2, the processor may project the above 3D vectors onto \vec{g} to calculate a loss in the two remaining dimensions. In other words, the processor may perform ∥Rᵢ \vec{g}−R_{ref}∥(\vec{g})∥ and may calculate a loss, based on projecting the vector in the direction of \vec{g}.

The processor may perform pose-graph optimization to obtain the updated pose (or position) information, based on an edge constraint and an odometry constraint, which are obtained in the calculation process described above, and may control the robot, based on the updated pose information.

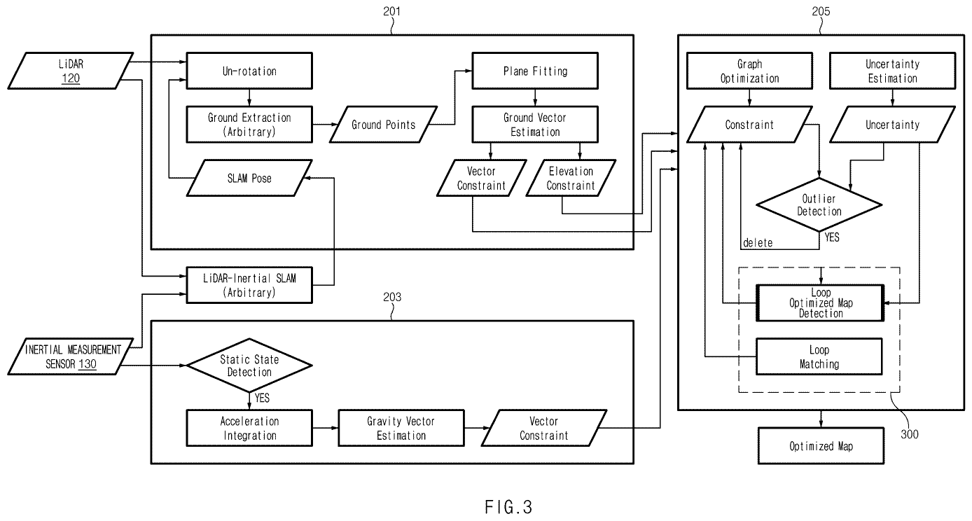

FIG. 3 illustrates an example of updating a map in a pose correction apparatus according to an embodiment of the present disclosure.

Referring to FIG. 3, a pose correction apparatus (e.g., a pose correction apparatus 100 of FIG. 1) according to an embodiment may include at least one of LiDAR 120 (e.g., LiDAR 120 of FIG. 1) or an inertial measurement sensor 130 (e.g., an inertial measurement sensor 130 of FIG. 1), or any combination thereof.

Contents duplicated with the description of the ground information detection module 201, the gravity information detection module 203, and the optimization module 205 described in FIG. 2 will be omitted and described.

In an embodiment, the processor may perform a loop closure 300 to facilitate correcting a global position of a robot, based on performing uncertainty estimation.

For example, the loop closure 300 may include at least one of loop detection or loop matching, or any combination thereof.

For example, the processor may perform loop detection to facilitate determining whether the robot passes through a position where the robot already passes again. The loop detection may include determining whether the position of the robot at a current time point is identical to a position of the robot, which was located in the past, based on sensor data (e.g., data obtained by the LiDAR 120 and/or data obtained by the inertial measurement sensor 130).

Particularly, the processor may perform loop detection, based on odometry information and sensor data. The odometry information may include data associated with a movement distance of the robot.

For example, the processor may perform loop matching to facilitate accurately comparing previous data with current data to find an optimal matching point. For example, because the position of the robot is able to minutely differ due to sensor noise or an error, the processor may perform position correction. When correct matching is performed, the processor may add at least one of a vector constraint or an elevation constraint, or any combination thereof to perform optimization of a map, in a pose graph of SLAM.

In detail, the processor may perform loop matching, based on at least one of a feature point or an iterative closest point (ICP), or any combination thereof. The processor may perform an optimization process of correcting the map and the position of the robot, based on that the loop matching is successfully performed.

By performing the above-mentioned loop closure 300, the processor may provide the effect of reducing an accumulated error, improving map consistency, and improving accuracy of localization.

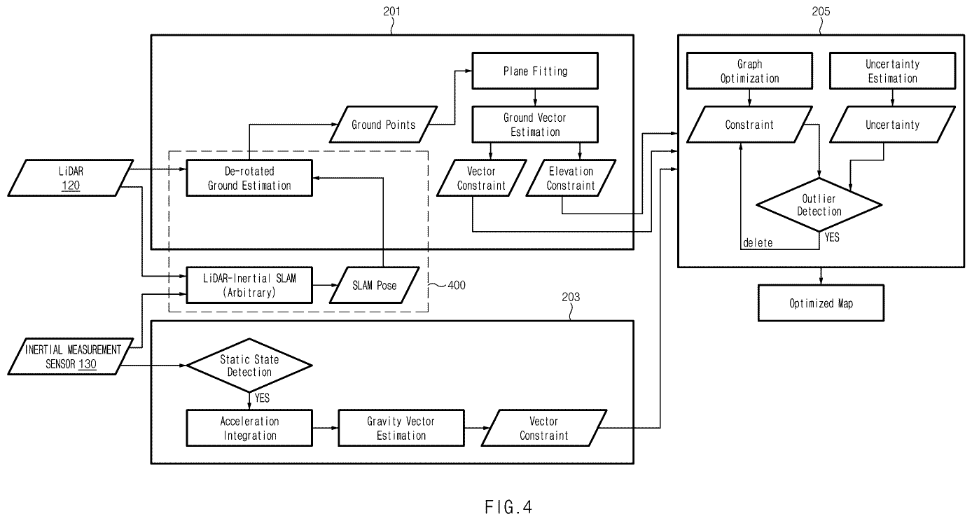

FIG. 4 illustrates an example of updating a map in a pose correction apparatus according to an embodiment of the present disclosure.

Referring to FIG. 4, a pose correction apparatus (e.g., a pose correction apparatus 100 of FIG. 1) according to an embodiment may include at least one of LiDAR 120 (e.g., LiDAR 120 of FIG. 1) or an inertial measurement sensor 130 (e.g., an inertial measurement sensor 130 of FIG. 1), or any combination thereof.

Contents duplicated with the description of the ground information detection module 201, the gravity information detection module 203, and the optimization module 205 described in FIG. 2 will be omitted and described. Particularly, a description will be given of contents associated with LiDAR-inertial SLAM, SLAM pose, and de-rotated ground estimation, which are included in a block 400.

In an embodiment, the processor may perform SLAM based on the LiDAR 120 and the inertial measurement sensor 130 (e.g., LiDAR-Inertial SLAM (Arbitrary) of FIG. 4). For example, the processor may combine data obtained via the LiDAR 120 with data obtained via the inertial measurement sensor 130 to generate a position of a robot and a map in real time. The processor may obtain precise position information, based on fusing distance data associated with a distance in the data obtained via the LiDAR 120 with acceleration and gyro data of the robot in the data obtained via the inertial measurement sensor 130.

In detail, the processor may obtain a point cloud corresponding to a surrounding environment around the robot, based on the data via the LiDAR 120. The processor may identify the position of the robot, based on the point cloud corresponding to the surrounding environment around the robot.

Furthermore, the processor may correct a pose of the robot, based on at least one of acceleration of the robot or an angular velocity of the robot, or any combination thereof, based on the data obtained via the inertial measurement sensor 130.

The processor may combine position information of the robot, which is obtained via the LiDAR 120, with pose information of the robot, which is obtained via the inertial measurement sensor 130. The processor may perform SLAM, based on combining the pose information of the robot, which is combined with the position information of the robot. The processor may provide the effect of performing the SLAM via the above process to estimate the accurate position of the robot in real time.

In an embodiment, the processor may use SLAM-based pose information (e.g., SLAM Pose of FIG. 4). For example, the processor may combine the data obtained via the LiDAR 120 with the data obtained via the inertial measurement sensor 130 to set an initial position. The processor may perform comparison with an existing map to calculate a distance in which the robot moves, based on identifying the surrounding environment around the robot via the LiDAR 120.

The processor may identify a change in pose of the robot, based on the data obtained via the inertial measurement sensor 130. The processor may reflect the change in pose of the robot to estimate the accurate pose of the robot at a current time point.

In an embodiment, the processor may perform de-rotated ground estimation of the ground (e.g., De-rotated Ground Estimation of FIG. 4) to obtain accurate pose information, even when the ground is tilted while the robot is moving. The processor may estimate a ground surface based on a ground point obtained via the LiDAR 120 and may align the ground surface again, using the data obtained via the inertial measurement sensor 130.

By performing the above process, the processor may provide the effect of combining the data obtained via the LiDAR 120 with the data obtained via the inertial measurement sensor 130 to identify (or estimate) the accurate position and pose of the robot and update the map.

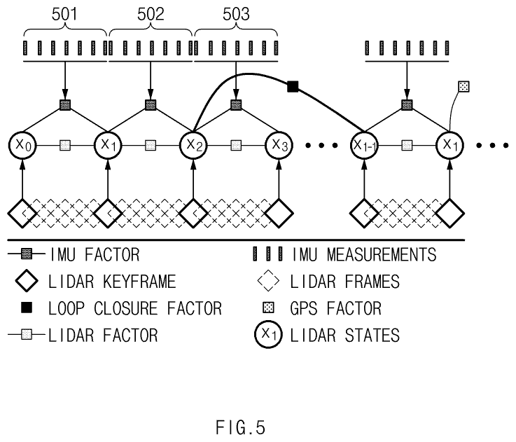

FIG. 5 illustrates an example of calculating uncertainty of factors, in an embodiment of the present disclosure.

Referring to FIG. 5, a pose correction apparatus (e.g., a pose correction apparatus 100 of FIG. 1) according to an embodiment may integrate pieces of data obtained via LiDAR (e.g., LiDAR 120 of FIG. 1) and/or an inertial measurement sensor (e.g., an inertial measurement sensor 130 of FIG. 1).

In an embodiment, a processor may obtain IMU measurements, via the inertial measurement sensor. For example, the processor may divide the IMU measurements into a plurality of datasets. For example, the processor may divide the IMU measurements into a first dataset 501, a second dataset 502, and a third dataset 503. However, an embodiment of the present disclosure is not limited thereto and divides the IMU measurements into the first to third datasets 501 to 503 for convenience of description.

In an embodiment, the processor may generate an IMU factor, using the first dataset 501, the second dataset 502, and the third dataset 503. For example, the IMU factor may include at least one of the acceleration of the robot or the angular velocity of the robot, or any combination thereof, which is obtained via the inertial measurement sensor. For example, the IMU factor may be used to correct continuous motion of the robot.

In FIG. 5, a LiDAR factor may include data obtained via the LiDAR. For example, the LiDAR factor may include a LiDAR keyframe and LiDAR frames. The LiDAR factor may be used for SLAM.

In an embodiment, when the current position of the robot is partially matched with a past position of the robot, the processor may perform a loop closure. The processor may reduce an accumulated position error by the performing the loop closure.

According to an embodiment, the processor may reduce a position error of the robot, using a GPS factor. For example, the GPS factor may include data associated with an absolute position of the robot, which is provided from a GPS. When there is data associated with the absolute position of the robot, which is obtained from the GPS, the processor may reduce the position error of the robot using the data.

In an embodiment, the processor may obtain a state of the robot, which is estimated by performing the SLAM based on the data obtained via LiDAR. In FIG. 5, the processor may obtain LiDAR states, using the LiDAR keyframe and the IMU factor. The LiDAR states may refer to states associated with the pose of the robot.

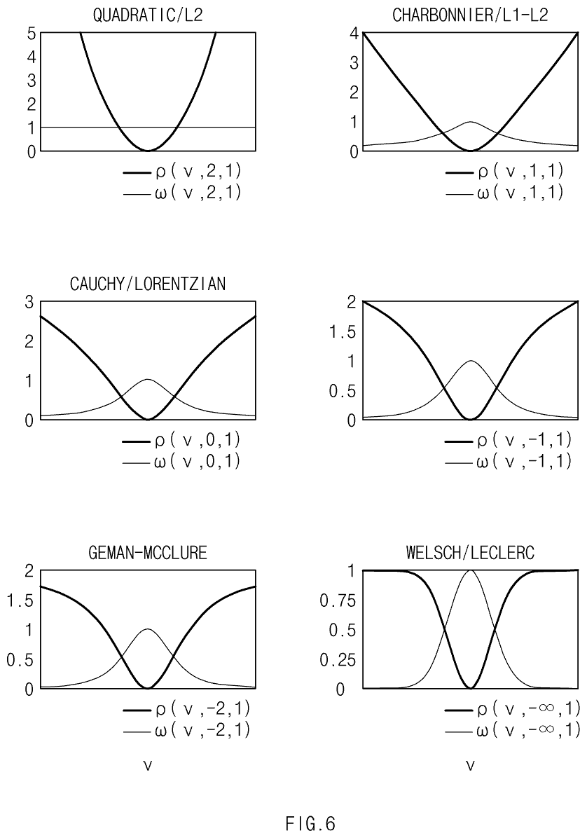

FIG. 6 illustrates an example of a graph associated with a robust kernel to facilitate removing an outlier, in an embodiment of the present disclosure.

Referring to FIG. 6, a processor (e.g., a processor 110 of FIG. 1) of a pose correction apparatus (e.g., a pose correction apparatus 100 of FIG. 1) according to an embodiment may remove an outlier using a robust kernel.

In the graph shown in FIG. 6, ρ may refer to a loss function. In the graph shown in FIG. 6, ω may refer to a weight function.

Quadratic/L2 shown in FIG. 6 may be used in a small error, but may be vulnerable to the outlier. When there is the outlier, the updated result may be greatly influenced.

Charbonnier/L1-L2 shown in FIG. 6 may be a compromise between L1 and L2, which may provide the effect of being similar to L2 when an error is small, but shows a gradual increase to reduce the outlier when the error is large.

Cauchy/Lorentzian shown in FIG. 6 may limit a loss to a certain level, although the error is large, and may strongly suppress the influence of the outlier.

Geman-McClure shown in FIG. 6 may be a kernel more robust to the outlier than Cauchy, which may provide the effect of being similar to L2 in a small error, but having a very small loss in a large error to effectively suppress the outlier.

Welsch/Leclerc shown in FIG. 6 may sharply reduce a weight, when the error is large, which may provide the effect of very strongly suppressing the outlier.

In an embodiment, the processor may effectively remove the outlier using at least one of the kernels described above.

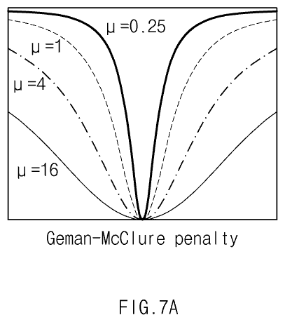

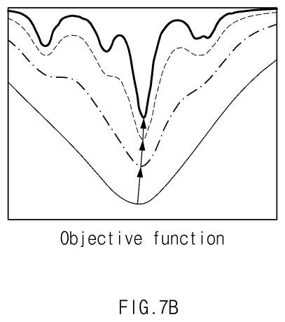

FIG. 7A illustrates an example of a graph associated with a Geman-McClure penalty function, in an embodiment of the present disclosure. FIG. 7B illustrates an example of a graph associated with an objective function, in an embodiment of the present disclosure.

Referring to FIGS. 7A and 7B, a processor (e.g., a processor 110 of FIG. 1) of a pose correction apparatus (e.g., a pose correction apparatus 100 of FIG. 1) according to an embodiment may perform uncertainty estimation, using a solver. For example, the solver may include an optimization solver including at least one of Ceres, general graph optimization (g20), or Georgia tech smoothing, and mapping (GTSAM), or any combination thereof.

The processor may suppress an outlier, using a Geman-McClure penalty function. The Geman-McClure penalty function may be a robust loss function robust to the outlier, which may vary in the form of a penalty according to a p value and may more reduce an influence on the outlier as the p value is larger.

The processor may perform an optimization process using an objective function. The processor may reduce instability which occurs due to the outlier using the objective function and may improve the optimization process. The form of the objective function disclosed in the present disclosure is an example and is not limited thereto.

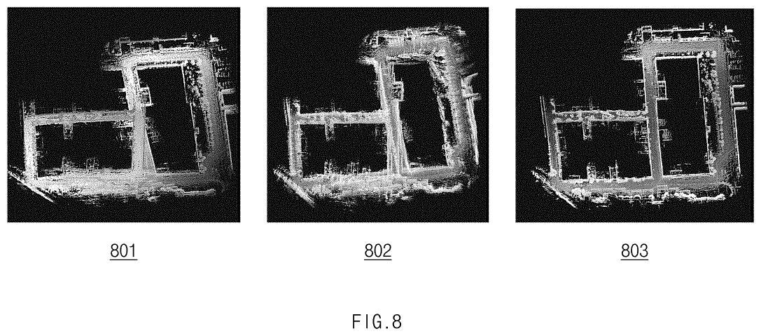

FIG. 8 illustrates an example of an updated map generated by a pose correction apparatus according to an embodiment of the present disclosure.

Referring to FIG. 8, a first map 801 may include an example of a map initially obtained by a robot. The first map 801 may include an initial map generated via SLAM, may have a distortion, and may have a map shape which differs somewhat from a real shape.

A second map 802 may include an example of partially correcting an initial map using a constraint. The second map 802 may have a structure which is more accurately aligned than the first map 801 by using data obtained from LiDAR (e.g., LiDAR 120 of FIG. 1) and an inertial measurement sensor (e.g., an inertial measurement sensor 130 of FIG. 1), but may have some distortions.

A third map 803 may include a map which applies a constraint and performs pose-graph optimization. The third map 803 may have more improved map consistency by performing graph optimization and may be the result of being corrected to a 3D map in the most realistic form. Pose information associated with the pose of the robot may be updated according to embodiments disclosed in the present disclosure, thus obtaining an accumulate map, such as the third map 803.

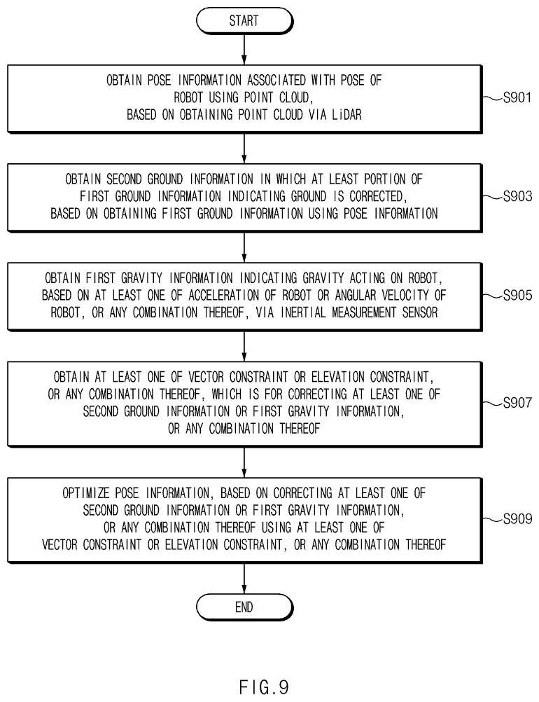

FIG. 9 illustrates an example of a flowchart associated with a pose correction method according to an embodiment of the present disclosure.

Hereinafter, it is assumed that a pose correction apparatus 100 of FIG. 1 performs in accord with FIG. 9. Furthermore, in a description of FIG. 9, it may be understood that an operation described as being performed by an apparatus is controlled by a processor 110 of the pose correction apparatus 100.

At least one of the operations of FIG. 9 may be performed by the pose correction apparatus 100 of FIG. 1. At least one of the operations of FIG. 9 may be controlled by the processor 110 of FIG. 1. The respective operations of FIG. 9 may be sequentially performed, but are not necessarily sequentially performed. For example, an order of the respective operations may be changed and at least two operations may be performed in parallel.

Referring to FIG. 9, in S901, the pose correction method according to an embodiment may include obtaining pose information associated with a pose of a robot using a point cloud, based on obtaining the point cloud via LiDAR (e.g., LiDAR 120 of FIG. 1).

For example, in S903, the pose correction method according to an embodiment may include obtaining second ground information in which at least a portion of first ground information indicating the ground is corrected, based on obtaining the first ground information using the pose information.

In S905, the pose correction method according to an embodiment may include obtaining first gravity information indicating gravity acting on the robot, based on at least one of acceleration of the robot or an angular velocity of the robot, or any combination thereof, via an inertial measurement sensor (e.g., an inertial measurement sensor 130 of FIG. 1).

The pose correction method according to an embodiment may include obtaining the first gravity information, while the robot is moving at less than predefined acceleration and a predefined angular velocity.

In S907, the pose correction method according to an embodiment may include obtaining at least one of a vector constraint or an elevation constraint, or any combination thereof, which is to facilitate correcting at least one of the second ground information or the first gravity information, or any combination thereof,

The pose correction method according to an embodiment may include estimating a ground vector associated with the ground, based on applying a plane fitting algorithm to the first ground information. The pose correction method may include obtaining the at least one of the vector constraint or the elevation constraint, or the any combination thereof, using the ground vector.

The pose correction method according to an embodiment may include updating a height of the robot, using a reference plane obtained via a plane equation generated by the plane fitting algorithm, based on obtaining the plane equation.

In S909, the pose correction method according to an embodiment may include updating the pose information, based on correcting the at least one of the second ground information or the first gravity information, or the any combination thereof using the at least one of the vector constraint or the elevation constraint, or the any combination thereof.

The pose correction method according to an embodiment may include obtaining second gravity information to facilitate reducing an error value indicating an error in the first gravity information, based on applying the at least one of the vector constraint or the elevation constraint, or the any combination thereof to the first gravity information.

The pose correction method according to an embodiment may include identifying whether there is an outlier in at least one of the second ground information or the second gravity information, or any combination thereof, based on applying at least one of graph optimization or uncertainty estimation, or any combination thereof to the at least one of the second ground information or the second gravity information, or the any combination thereof.

The pose correction method according to an embodiment may include removing the outlier from the at least one of the second ground information or the second gravity information, or the any combination thereof, when there is the outlier in the at least one of the second ground information or the second gravity information, or the any combination thereof. The pose correction method may include updating the pose information, using at least one of the second ground information in which the outlier is removed or the second gravity information in which the outlier is removed, or any combination thereof.

The pose correction method according to an embodiment may include updating the pose information, using the at least one of the second ground information or the second gravity information, or the any combination thereof, when there is no outlier in the at least one of the second ground information or the second gravity information, or the any combination thereof. In detail, the pose correction method may include updating the pose information, using the at least one of the second ground information or the second gravity information, or the any combination thereof, when there is no outlier in both the second ground information and the second gravity information.

The pose correction method according to an embodiment may include applying the uncertainty estimation to the at least one of the second ground information or the second gravity information, or the any combination thereof. The pose correction method may include analyzing position information about the position of the robot, based on applying the uncertainty estimation to the at least one of the second ground information or the second gravity information, or the any combination thereof. The pose correction method may include updating the pose information, based on the position information.

The pose correction method according to an embodiment may include updating map information, based on updating the pose information. For example, the updating may include adjusting a position of an obstacle located around the robot included in the map or adjusting a height of the obstacle. However, an embodiment of the present disclosure is not limited to those described above.

As described above, the pose correction method according to an embodiment may provide the effect of updating the pose of the robot and updating the map using the updated pose of the robot to generate the accurate map.

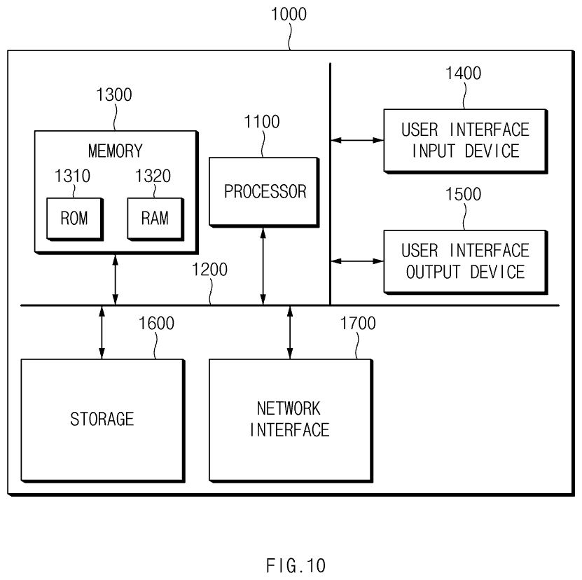

FIG. 10 illustrates a computing system associated with a pose correction apparatus or a pose correction method according to an embodiment of the present disclosure.

Referring to FIG. 10, a computing system 1000 may include at least one processor 1100, a memory 1300, a user interface input device 1400, a user interface output device 1500, a storage 1600, and a network interface 1700, which are connected with each other via a bus 1200.

The processor 1100 may be a central processing unit (CPU) or a semiconductor device that processes instructions stored in the memory 1300 and/or the storage 1600. The memory 1300 and the storage 1600 may include various types of volatile or non-volatile storage media. For example, the memory 1300 may include a read only memory (ROM) 1310 and a random access memory (RAM) 1320.

Accordingly, the operations of the method or algorithm described in connection with the embodiments disclosed in the specification may be directly implemented with a hardware module, a software module, or a combination of the hardware module and the software module, which is executed by the processor 1100. The software module may reside on a storage medium (i.e., the memory 1300 and/or the storage module 1600) such as a RAM, a flash memory, a ROM, an EPROM, an EEPROM, a register, a hard disc, a removable disk, and a CD-ROM.

The exemplary storage medium may be coupled to the processor 1100. The processor 1100 may read out information from the storage medium and may write information in the storage medium. Alternatively, the storage medium may be integrated with the processor 1100. The processor and the storage medium may reside in an application specific integrated circuit (ASIC). The ASIC may reside within a user terminal. In another case, the processor and the storage medium may reside in the user terminal as separate components.

The present technology may update pose information associated with a pose of a robot, using LiDAR and an inertial measurement sensor.

Furthermore, the present technology may obtain at least one of a vector constraint or an elevation constraint, or any combination thereof, based on sensor data obtained via the LiDAR and the inertial measurement sensor, may update the pose information associated with the pose of the robot using it, and may update map information based on the updated pose information.

In addition, various effects ascertained directly or indirectly through the present disclosure may be provided.

Hereinabove, although the present disclosure has been described with reference to exemplary embodiments and the accompanying drawings, the present disclosure is not limited thereto, but may be variously modified and altered by those skilled in the art to which the present disclosure pertains without departing from the spirit and scope of the present disclosure claimed in the following claims.

Therefore, embodiments of the present disclosure are not intended to limit the technical spirit of the present disclosure, but provided only for the illustrative purpose. The scope of the present disclosure should be construed on the basis of the accompanying claims, and all the technical ideas within the scope equivalent to the claims should be included in the scope of the present disclosure.

What is claimed is:

1. A pose correction apparatus, comprising:
a light detection and ranging (LiDAR);
an inertial measurement sensor; and
a processor,
wherein the processor is configured to:
obtain pose information associated with a pose of a robot using a point cloud, based at least in part on obtaining the point cloud by at least the LiDAR;
obtain a second ground information in which at least a portion of a first ground information indicating a ground is corrected, based at least in part on obtaining the first ground information using the pose information;
obtain a first gravity information indicating gravity acting on the robot, based at least in part on obtaining, by the inertial measurement sensor, at least one or more of: acceleration of the robot, or an angular velocity of the robot;
obtain at least one or more of: a vector constraint, or an elevation constraint; and
update the pose information, based at least in part on correcting one or more of: the second ground information, or the first gravity information with respect to one or more of: the vector constraint, or the elevation constraint.

2. The pose correction apparatus of claim 1, wherein the processor is configured to:
estimate a ground vector associated with the ground, based at least in part on applying a plane fitting algorithm to the first ground information; and
obtain the at least one or more of the vector constraint or the elevation constraint using the ground vector.

3. The pose correction apparatus of claim 2, wherein the processor is configured to:
update a height of the robot, using a reference plane obtained via a plane equation generated by the plane fitting algorithm, based at least in part on obtaining the plane equation.

4. The pose correction apparatus of claim 1, wherein the processor is configured to:
obtain the first gravity information, while the robot is moving at less than predefined acceleration or a predefined angular velocity.

5. The pose correction apparatus of claim 1, wherein the processor is configured to:
obtain second gravity information to facilitate reducing an error value indicating an error in the first gravity information, based at least in part on applying the at least one or more of: the vector constraint, or the elevation constraint.

6. The pose correction apparatus of claim 5, wherein the processor is configured to:
determine whether there is an outlier in at least one or more of: the second ground information, or the second gravity information, based at least in part on applying at least one or more of: graph optimization, or uncertainty estimation, to the at least one or more of: the second ground information, or the second gravity information.

7. The pose correction apparatus of claim 6, wherein the processor is configured to:
remove the outlier from the at least one or more of: the second ground information, or the second gravity information, when there is the outlier in the at least one or more of: the second ground information, or the second gravity information; and
update the pose information, using the at least one or more of: the second ground information, or the second gravity information, the at least one in which the outlier is removed.

8. The pose correction apparatus of claim 6, wherein the processor is configured to:
update the pose information, using the at least one or more of: the second ground information, or the second gravity information, at least when there is no outlier in the at least one or more of: the second ground information, or the second gravity information.

9. The pose correction apparatus of claim 6, wherein the processor is configured to:
analyze position information about a position of the robot, based at least in part on applying the uncertainty estimation to the at least one or more of: the second ground information, or the second gravity information; and
update the pose information, based at least in part on analyzing the position information.

10. A pose correction method, comprising:
obtaining pose information associated with a pose of a robot using a point cloud, based at least in part on obtaining the point cloud via a light detection and ranging (LiDAR);
obtaining a second ground information in which at least a portion of a first ground information indicating a ground is corrected, based at least in part on obtaining the first ground information using the pose information;
obtaining first gravity information indicating at least gravity acting on the robot, based at least in part on obtaining, by an inertial measurement sensor, at least one or more of: acceleration of the robot, or an angular velocity of the robot; and
updating the pose information, based at least in part on correcting one or more of: the second ground information, or the first gravity information, with respect to one or more of: a vector constraint, or an elevation constraint.

11. The pose correction method of claim 10, comprising:
estimating a ground vector associated with the ground, based on applying a plane fitting algorithm to the first ground information; and
obtaining the at least one or more of the vector constraint or the elevation constraint using the ground vector.

12. The pose correction method of claim 11, comprising:
updating a height of the robot, using a reference plane obtained via a plane equation generated by the plane fitting algorithm, based on obtaining the plane equation.

13. The pose correction method of claim 10, comprising:
obtaining the first gravity information, while the robot is moving at less than predefined acceleration or a predefined angular velocity.

14. The pose correction method of claim 10, comprising:
obtaining second gravity information to facilitate reducing an error value indicating an error in the first gravity information, based on applying the at least one or more of: the vector constraint, or the elevation constraint to the first gravity information.

15. The pose correction method of claim 14, comprising:
determining whether there is an outlier in at least one or more of: the second ground information, or the second gravity information based on applying at least one or more of: graph optimization, or uncertainty estimation, to the at least one or more of: the second ground information, or the second gravity information.

16. The pose correction method of claim 15, comprising:
removing the outlier from the at least one or more of: the second ground information, or the second gravity information, at least when there is the outlier in the at least one or more of: the second ground information, or the second gravity information; and
updating the pose information, using the at least one or more of: the second ground information, or the second gravity information, the at least one in which the outlier is removed.

17. The pose correction method of claim 15, comprising:
updating the pose information, using the at least one or more of: the second ground information, or the second gravity information, at least when there is no outlier in the at least one or more of: the second ground information, or the second gravity information.

18. The pose correction method of claim 15, comprising:
analyzing position information about a position of the robot, based on applying the uncertainty estimation to the at least one or more of: the second ground information, or the second gravity information; and
updating the pose information, based on analyzing the position information.

19. A non-transitory computer-accessible media storing instructions that, when accessed by a processor, cause the processor to:
obtain pose information associated with a pose of a robot using a point cloud, based at least in part on obtaining the point cloud by at least a light detection and ranging (LiDAR);
obtain a second ground information in which at least a portion of a first ground information indicating the ground is corrected, based at least in part on obtaining the first ground information using the pose information;
obtain first gravity information indicating gravity acting on the robot, based at least in part on obtaining sensor data by an inertial measurement sensor configured to determine at least an acceleration of the robot, or an angular velocity of the robot; and
update the pose information, based at least in part on correcting one or more of: the second ground information, or the first gravity information with respect to one or more of: a vector constraint, or an elevation constraint.

20. The media of claim 19, the instructions including further instructions to:
update a map information corresponding to a surrounding environment around the robot, based at least in part on updating the pose information; and
pose the robot based at least in part on updating the pose information.
